(19) United States
(12) Patent Application Publication
(10) Pub. No.: US 2014/0143710 A1
(43) Pub. Date: May 22, 2014

(54) SYSTEMS AND METHODS TO CAPTURE AND SAVE CRITERIA FOR CHANGING A DISPLAY CONFIGURATION

(71) Applicants: Qi Zhao, Park Ridge, NJ (US); Christopher John Olivier, Park Ridge, NJ (US)

(72) Inventors: Qi Zhao, Park Ridge, NJ (US); Christopher John Olivier, Park Ridge, NJ (US)

(21) Appl. No.: 13/683,882

(22) Filed: Nov. 21, 2012

(51) Int. Cl. G06F 3/0482

(52) U.S. Cl. CPC G06F 3/0482
USPC 715/781; 715/835

(57) ABSTRACT

An example method for displaying clinical content includes monitoring user interaction with an image viewer displaying clinical content to a user according to a hanging protocol. The example method includes identifying a change in configuration of the hanging protocol and capturing, based on user input, criteria associated with the change. The example method includes saving the criteria in association with the hanging protocol and providing the saved hanging protocol and associated criteria for selection and application to clinical content to be displayed.

### BACKGROUND OF THE INVENTION

The present disclosure relates to criteria for presentation display rules in a picture archiving and communication system. More particularly, the present invention relates to systems and methods to capture and save criteria relating to changes made to a hanging protocol configuration.

Healthcare environments, such as hospitals or clinics, include clinical information systems, such as hospital information systems (“HIS”) and radiology information systems (“RIS”), and storage systems, such as picture archiving and communication systems (“PACS”). Information stored in these storage systems may include patient medical histories, imaging data, test results, diagnosis information, management information, and/or scheduling information, for example. The information may be centrally stored or divided at a plurality of locations. Healthcare practitioners often need access to patient information and/or other information at various points in a healthcare workflow. For example, during surgery, medical personnel may need access to patient information, such as images of a patient's anatomy, which are stored in a medical information system. Radiologists and/or other clinicians may review the stored images and/or other information, for example.

A reading, such as a radiology or cardiology procedure reading, is a process conducted by a healthcare practitioner, such as a radiologist or a cardiologist, for viewing digital images of a patient. The practitioner performs a diagnosis based on content of the diagnostic images and reports on results electronically (e.g., using dictation or otherwise) or on paper. The practitioner, such as a radiologist or cardiologist, also uses other tools to perform diagnosis. Some examples of other tools are prior and related prior (historical) exams and their results, laboratory exams (such as blood work), allergies, pathology results, medication, alerts, document images, and other tools.

PACS connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS is to provide one or more medical images for examination by a medical professional such as, for example, a radiologist or cardiologist. For example, a PACS can provide a series of x-ray images to a display workstation where the images are displayed for a radiologist to perform a diagnostic examination. Based on the presentation of these images, the radiologist can provide a diagnosis. For example, the radiologist can diagnose a tumor or lesion by viewing the x-ray images of a patient's lungs.

The workstation can display the images in the imaging study to a radiologist in order to permit the radiologist to perform a diagnostic examination. The review or analysis of images in an imaging study is referred to as reading the imaging study. Based on the presentation of the images in the imaging study, the radiologist can provide a diagnosis. For example, the radiologist can diagnose a tumor or lesion in x-ray images of a patient's lungs.

Medical imaging devices now produce diagnostic images in a digital representation. The digital representation typically includes a two dimensional raster of the image equipped with a header including collateral information with respect to the image itself, patient demographics, imaging technology, and other data used for proper presentation and diagnostic interpretation of the image. Often, diagnostic images are grouped in series, where each series represents images that have some commonality and differ in one or more details. For example, images representing anatomical cross-sections of a human body substantially normal to its vertical axis and differing by their position on that axis from top (head) to bottom (feet) are grouped in so-called axial series. A single medical exam often referred as a “study” or an “exam” typically includes one or more series of images, such as images exposed before and after injection of contrast material or images with different orientation or differing by any other relevant circumstance(s) of imaging procedure. The digital images are forwarded to specialized archives equipped with proper means for safe storage, search, access, and distribution of the images and collateral information for successful diagnostic interpretation.

The images in an imaging study typically are displayed in a particular spatial layout and/or temporal sequence. In other words, the images may be displayed (e.g., presented) in certain positions on a display device relative to each other (e.g., a spatial layout). The images may also be displayed in a certain ordered sequence by displaying image A first, followed by image B, followed by image C, and so on (e.g., a temporal sequence). The spatial and/or temporal presentation of images is directed by a set of display rules. A display rule may include a set of instructions stored on a computer-readable media that direct the presentation of the images and/or series on a display workstation. A set of display rules is known as a hanging protocol. In general, a hanging protocol is a series of display rules that dictate the spatial and/or temporal layout and presentation of a plurality of images and/or series of the imaging study. Existing hanging protocols are either hard coded or static, as the hanging protocols are unable to adapt to changes made by a user while reading an imaging study. Instead, a separate hanging protocol editor must be used off-line to configure a new hanging protocol and/or modify an existing hanging protocol.

A hanging protocol for radiology workstations may rely on, for example, the following factors to layout the images in an imaging study: (a) imaging modality (modalities-in case of multi-modality hanging protocol) used to obtain images in the study, (b) body part or anatomy imaged in the study, (c) imaging procedure used to obtain the images of the study, (d) the resolution of the workstation (for example, the number of monitors) and (e) the number of historical imaging studies.

When applying a hanging protocol, current systems group images according to characteristics such as Digital Imaging and Communications in Medicine (DICOM) series or series number. These systems use individual data elements of an image's DICOM header and HL-7 order information to classify a study type and determine how the study should be displayed. Other systems attempt to prepare images for viewing by users by applying a series of processing steps or functions included in a Default Display Protocol (“DDP”).

However, in most cases, a single hanging protocol is not enough for a radiologist to read the complete study, since the study contains a number of images and/or series (e.g., a group of images). That is, a particular hanging protocol is unlikely to be suitable for all reviews and analyses of imaging studies. For example, some hanging protocols may not present side-by-side comparisons of current and historical imaging studies, while other hanging protocols may provide such a presentation. The “side-by-side presentation” protocols can be better suited for certain imaging studies and analyses, while the other protocols may not.

Therefore, users of a given hanging protocol often desire to make additional alterations or changes after the hanging protocol has been implemented. For example, a user may wish to include additional display rules to alter or modify a presentation of images and/or series on a user display after the hanging protocol has arranged the presentation of the images and/or series. In another example, the user may wish to present additional images and/or series adjacent to currently displayed images and/or series, present certain images within the series, view alternate orientations of a given body part, etc. Some known systems that allow users to modify a hanging protocol require the user to manually modify or edit the display rules of the hanging protocol in a separate or off-line hanging protocol editor. However, these known systems are often time consuming and cumbersome to a user.

### BRIEF SUMMARY

Example systems and methods capture and save criteria relating to changes made in a display configuration.

An example method for displaying clinical content includes monitoring user interaction with an image viewer displaying clinical content to a user according to a hanging protocol. The example method includes identifying a change in configuration of the hanging protocol. The example method includes capturing, based on user input, criteria associated with the change. The example method includes saving the criteria in association with the hanging protocol. The example method includes providing the hanging protocol and associated criteria for selection and application to clinical content to be displayed.

An example system for displaying clinical content includes a user interface to display clinical content to a user based on a hanging protocol. The example system includes a processing unit to identify a change in configuration of the hanging protocol made by the user interacting with the clinical content, present the user with criteria associated with the change, capture, based on user input, one or more of the criteria, save the criteria with the hanging protocol, and provide the hanging protocol for application to clinical content to be displayed.

An example tangible computer readable medium having a set of instructions that when read, cause the computer to at least display a first image study to a user based on a hanging protocol configuration. The example instructions cause the computer to monitor user interaction with the first image study. The example instructions cause the computer to identify a change in configuration of the hanging protocol. The example instructions cause the computer to capture criteria associated with the change. The example instructions cause the computer to save the criteria in association with the hanging protocol. The example instructions cause the computer to provide the hanging protocol and saved criteria for selection and application to a second image study different than the first image study.

### BRIEF DESCRIPTION OF SEVERAL VIEWS OF THE DRAWINGS

FIG. 1 illustrates an example picture archiving and communication system.

FIG. 2 shows an example of a display system to capture and save criteria associated with a change to a hanging protocol.

FIG. 3a illustrates an example user interface for reviewing images.

FIG. 3b illustrates the example interface of FIG. 3a with an alternative display arrangement.

FIG. 3c illustrates the example interface of FIG. 3a with an alternative display arrangement.

FIG. 4 illustrates an example hanging criteria window to select criteria.

FIG. 5 illustrates a flow diagram of an example method to capture and save criteria associated with a change to a hanging protocol.

FIG. 6 illustrates a flow diagram of an example method to apply a hanging protocol with saved criteria.

FIG. 7 is a block diagram of an example processor system that may be used to execute the machine readable instructions of FIGS. 5 and 6 to implement the example the user display systems of FIGS. 1, 2 3a-3c and/or 4.

### DETAILED DESCRIPTION OF CERTAIN EMBODIMENTS

Although this specification discloses example methods, systems and computer readable medium including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the following describes example methods, systems, and computer readable medium persons of ordinary skill in the art will readily appreciate that the examples provided are not the only way to implement such methods, systems and computer readable medium.

With such a wide range of clinical content (e.g., image studies), a given hanging protocol (e.g., a set of display rules) is not always the most practical and beneficial across the different types of image studies. Users often desire to make additional alterations or changes to a hanging protocol configuration after the hanging protocol has been implemented. Some known systems allow a user to manually modify the display rules of the hanging protocol. Also, some known systems allow a user to manually create a display configuration and save the configuration as a hanging protocol. However, these known systems are often time consuming and redundant. These known systems typically require a user to manually modify the display rules in a separate and/or off-line hanging protocol editor. Even after creating new display rules, these known systems still rigidly apply the display rules and, thus, present the same difficulties when applying the hanging protocol to another study (e.g., the user may desire to make further changes).

The example methods and systems for displaying clinical content (e.g., image studies, readings, images, series, etc.) described herein capture and save criteria associated with changes (e.g., adjustments, modifications, alterations) made to an existing hanging protocol configuration and enable a user to easily change and save presentation parameters in the existing hanging protocol. By capturing and saving the criteria relied on when making certain changes, the example methods and systems provide a hanging protocol that more adequately presents clinical content without the need to make similar changes when displaying other image studies. Further, by allowing the system to quickly save the criteria relating to the user reasoning (e.g., intentions, purposes, justifications, rationalizations) for the changes made, without the need to manually modify display rules in an off-line editor, the system can better learn and apply or fit a hanging protocol configuration to a particular user viewing circumstance, and thus, increase the efficiency of a reading.

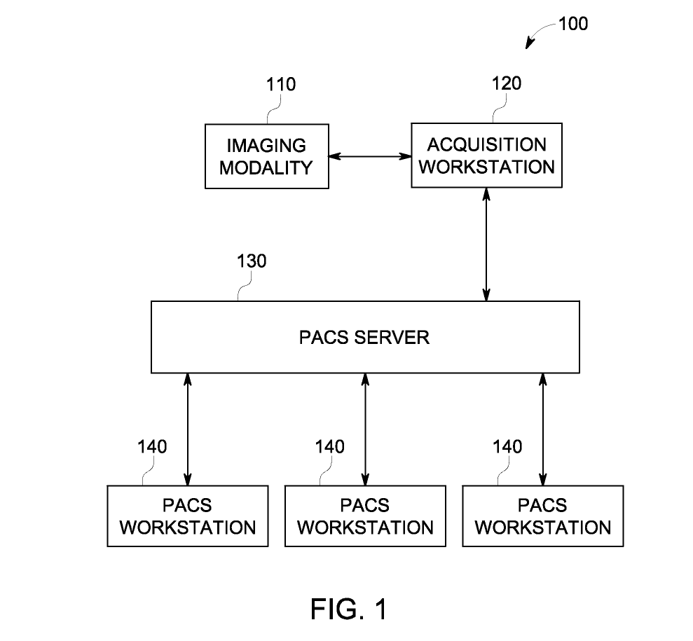

FIG. 1 illustrates an exemplary Picture Archiving and Communication System (“PACS”) 100 used in accordance with the example display systems and methods disclosed herein. The PACS 100 includes an imaging modality 110, an acquisition workstation 120, a PACS server 130, and one or more PACS workstations 140. The system 100 may include any number of imaging modalities 110, acquisition workstations 120, PACS server 130 and PACS workstations 140 and is not in any way limited to the embodiment of system 100 illustrated in FIG. 1. The components of the system 100 may communicate via wired and/or wireless communication, for example, and may be separate systems and/or integrated to varying degrees, for example.

In operation, the imaging modality 110 obtains one or more images of a patient anatomy. The imaging modality 110 may include any device capable of capturing an image of a patient anatomy such as a medical diagnostic imaging device. For example, the imaging modality 110 may include an X-ray imager, ultrasound scanner, magnetic resonance imager, or the like. Image data representative of the image(s) is communicated between the imaging modality 110 and the acquisition workstation 120. The image data may be communicated electronically over a wired or wireless connection, for example.

In an embodiment, the acquisition workstation 120 may apply one or more preprocessing functions, for example, to the image data in order to prepare the image for viewing on a PACS workstation 140. For example, the acquisition workstation 120 may convert raw image data into a Digital Imaging and Communications in Medicine (“DICOM”) standard format or attach a DICOM header. Preprocessing functions may be characterized as modality-specific enhancements, for example (e.g., contrast or frequency compensation functions specific to a particular X-ray imaging device), applied at the beginning of an imaging and display workflow. The preprocessing functions differ from processing functions applied to image data in that the processing functions are not modality specific and are instead applied at the end of the imaging and display workflow (for example, at a display workstation 140).

The image data may then be communicated between the acquisition workstation 120 and the PACS server 130. The image data may be communicated electronically over a wired or wireless connection, for example.

The PACS server 130 may include computer-readable storage media suitable for storing the image data for later retrieval and viewing at a PACS workstation 140. The PACS server 130 may also include one or more software applications for additional processing and/or preprocessing of the image data by one or more PACS workstations 140.

One or more PACS workstations 140 are capable of or configured to communicate with the server 130. The PACS workstations 140 may include a general purpose processing circuit, a PACS server 130 interface, a software memory, and/or an image display monitor, for example. The PACS server 130 interface may be implemented as a network card connecting to a TCP/IP based network, but may also be implemented as a parallel port interface, for example.

The PACS workstations 140 may retrieve or receive image data from the server 130 for display to one or more users. For example, a PACS workstation 140 may retrieve or receive image data representative of a computed radiography (“CR”) image of a patient's chest. A radiologist or user may then examine the image for any objects of interest, such as tumors, lesions, etc., for example.

The PACS workstations 140 may also be capable of or configured to apply processing functions to image data. For example, a user may desire to apply processing functions to enhance features within an image representative of the image data. Processing functions may therefore adjust an image of a patient anatomy in order to ease a user's diagnosis of the image. Such processing functions may include any software-based application that may alter a visual appearance or representation of image data. For example, a processing function can include any one or more of flipping an image, zooming in an image, panning across an image, altering a window and/or level in a grayscale representation of the image data, and altering a contrast and/or brightness an image.

In an embodiment, the PACS 100 may provide one or more perspectives for viewing images and/or accessing applications at a PACS workstation 140. Perspectives may be provided locally at the PACS workstation 140 and/or remotely from the PACS server 130. In an embodiment, the PACS 100 includes a perspectives manager capable of being used for reviewing images via a plurality of perspectives. The PACS server 130 and/or a PACS workstation 140 may include the perspectives manager, or the perspectives manager may be implemented in a separate system. In an embodiment, each PACS workstation 140 may include a perspectives manager.

In operation, for example, a user, such as a radiologist, selects a set of images, such as screening mammogram images, chest screening images and/or other computed radiography (“CR”), digital radiography (“DR”), and/or digital x-ray (“DX”) screening images, to review at a PACS workstation 140. The images may be displayed in a default perspective and/or a customized perspective, for example.

PACS workstations 140 may retrieve or receive image data from server 130 for display to one or more users. For example, a PACS workstation 140 may retrieve or receive image data representative of a computed radiography image of a patient's chest. A radiologist may then examine the image as displayed on a display device for any objects of interest such as, for example, tumors, lesions, etc.

PACS workstations 140 are also capable of or configured to retrieve and/or receive one or more hanging protocols from server 130. For example, a default hanging protocol may be communicated to PACS workstation 140 from server 130. A hanging protocol may be communicated between server 130 and a PACS workstation 140 over a wired or wireless connection, for example.

In general, PACS workstations 140 may present images representative of image data retrieved and/or received from server 130. PACS workstations 140 may present the images according to a hanging protocol. A hanging protocol is a set of display rules for presenting, formatting and otherwise organizing images and/or series on a display device of a PACS workstation 140. A display rule is a convention for presenting one or more images and/or series in a particular temporal and/or spatial layout or sequence. For example, a hanging protocol may include a set of computer-readable instructions (or display rules, for example) that direct a computer to display a plurality of images and/or series in certain locations on a display device and/or display the plurality of images and/or series in a certain sequence or order. In another example, a hanging protocol may include a set of computer-readable instructions that direct a computer to place a plurality of images and/or series in multiple screens and/or viewports on a display device. In general, a hanging protocol may be employed to present a plurality of images and/or series for a diagnostic examination of a patient anatomy featured in the images and/or series.

A hanging protocol may direct, for example, a PACS workstation 140 to display an anterior-posterior (“AP”) image adjacent to a lateral image of the same anatomy. In another example, a hanging protocol may direct PACS workstation 140 to display the AP image before displaying the lateral image. In general, a hanging protocol dictates the spatial and/or temporal presentation of a plurality of images and/or series at PACS workstation 140.

A hanging protocol may differ from a default display protocol (“DDP”). However, the terms may also be used interchangeably and/or in overlapping circumstances. In general, a DDP is a default workflow that applies a series of image processing functions to image data. The image processing functions are applied to the image data in order to present an image (based on the image data) to a user. The image processing functions alter the appearance of image data. For example, an image processing function may alter the contrast level of an image.

DDPs typically include processing steps or functions that are applied before any diagnostic examination of the images. For example, processing functions may be applied to image data in order to enhance features within an image (based on the image data). Such processing functions can include any software-based application that may alter a visual appearance or representation of image data. For example, a processing function can include any one or more of flipping an image, zooming in an image, panning across an image, altering a window and/or level setting in a representation of the image data, and altering a contrast and/or brightness setting in a representation of the image data.

DDPs are usually based on a type of imaging modality used to obtain the image data. For example, image data obtained with a C-arm imaging device in general or a particular C-arm imaging device may have a same or similar DDP applied to the image data. In general, a DDP attempts to present image data in a manner most useful to many users.

Conversely, applying a hanging protocol to image data may or may not alter the appearance of an image (based on the image data), but may instead dictate how the image(s) is (are) presented (e.g., the spatial layout), as described above.

Server 130 may store a plurality of hanging protocols and/or DDPs. The hanging protocols and/or DDPs that are stored at server 130 and have not yet been modified or customized are default hanging protocols/DDPs. A default hanging protocol and/or DDP may be selected from a plurality of default hanging protocols and/or DDPs based on any number of relevant factors such as, for example, a manual selection, a user identity, and/or pre-processing of the image data.

Specifically, a default hanging protocol and/or DDP may be selected based on a manual selection simply by communicating the default protocol once a user has selected that particular protocol. The user may make the selection, for example, at a PACS workstation 140.

In another example, a default protocol may be selected based on a user identity. For example, a user may have a preferred DDP. The DDP may have been customized to meet the user's preferences for a particular temporal and/or spatial layout of images. Once a user gains access to a PACS workstation 140 (for example, by entering a correct login and password combination or some other type of user identification procedure), the preferred DDP may be communicated to the PACS workstation 140, for example.

In another example, a default protocol may be selected based on pre-processing of image data. Pre-processing of image data may include any image processing known to those of ordinary skill in the art that prepares an image for review by a user. Pre-processing may also include, for example, a computer-aided diagnosis (“CAD”) of image data. CAD of image data may include a computer (or similar operating unit) automatically analyzing image data for objects of interest. For example, a CAD may include a software application that analyzes image data for nodules in images of lungs, lesions, tumors, etc. However, a CAD application can include any automatic analysis of image data known to those of ordinary skill in the art.

For example, a default hanging protocol that corresponds to CAD findings of lung tumors may provide for the presentation of the posterior-anterior (“PA”) and lateral lung images adjacent to each other followed by the presentation of the computed tomography (“CT”) lung images, followed by the magnetic resonance (“MR”) lung images, for example. In general, a default hanging protocol that corresponds to CAD findings is designed to present images in a spatial and/or temporal layout that is useful to a radiologist. For example, a radiologist may be greatly assisted in his or her review of the CAD findings by viewing the PA and lateral lung images adjacent to each other, followed by previously acquired multi-slice CT and MR images of the lungs.

Therefore, based on CAD findings, a default protocol may be selected from a plurality of default protocols and applied at a workstation 140 in order to present images to a user.

PACS users often wish to run multiple applications on a PACS workstation 140. In addition to a primary PACS workflow or interface application, a user may wish to access other applications such as surgical planning tools, scheduling tools, electronic mail viewers, image processing tools, and/or other tools. For example, PACS users often like to use a PACS workflow engine while viewing electronic mail and accessing information on the Internet. Users of an integrated RIS/PACS may wish to access both RIS and PACS applications simultaneously. Typically, however, the PACS application occupies all active display area and hides other applications running on the workstation 140. For example, in a PACS workstation 140 having three monitors, the PACS workflow application occupies all three monitors. When an application is initiated, another application may be displaced, or the application may be launched in a sub-optimal display area. For example, a user may launch a data management or diagnostic processing software at a three-monitor PACS workstation 140, and the application may launch on a color monitor, displacing images displayed on the color monitor. Typically, a user would have to manually reorganize applications to display the management application on a grayscale monitor and the images on the higher resolution color monitor.

Some examples provide an adaptable PACS 100 accommodating a plurality of displays such that each display operates with a separate display window. All display windows are controlled internally by a primary window that is transparent to users. The primary, transparent window tracks which window or windows have the PACS application and which window(s) have other applications and/or data. Thus, the PACS application and other applications may be simultaneously displayed on a plurality of displays.

Some examples provide dynamic configuration of displays associated with PACS workstation 140. The primary window allows interaction or application(s) and data across multiple windows. The PACS workstation 140 operates a transparent, primary window including a plurality of windows across a plurality of displays.

Selection of a hanging/display protocol on a PACS workstation may be based on a plurality of criteria, such as a number of connected displays, a modality, an anatomy, and a procedure, for example. Based on these criteria, a user may create multiple protocols with one default protocol used to display an image study. For example, a hanging protocol may be created for a particular display configuration. A user creates different hanging protocols to properly display a study on different display configurations.

In some examples, after the PACS 100 has applied a particular hanging protocol to present an image study on a display device such as, for example, PACS workstation 140, a user often desires to make additional changes or apply additional processing steps to one or more images to further enhance features in the image study. For example, a user may desire to apply additional processing functions or steps to an image and/or series in order to alter the presentation of an image and/or series in conformance with the user's confidence level for making an accurate diagnosis. In other words, different users may desire to apply different or additional processing steps than are included in a default or custom image processing workflow.

The additional changes or image processing step(s) may include any image processing step useful to prepare an image for a diagnostic examination. For example, as described above, an image processing step (as a default image processing step or an additional image processing step) can include flipping an image, zooming in an image, panning across an image, and altering one or more of a window, a level, a brightness and a contrast setting of an image. Image data may be displayed on a PACS workstation 140 using the same and/or different processing, display protocol, and/or perspective as other image(s), for example.

The example methods and systems described herein capture criteria used for making a particular change (e.g., adjustment, modification, alteration, action) to an existing hanging protocol configuration. The example methods and systems also enable a user to easily and quickly change (e.g., modify) and save presentation parameters (e.g., a window level, a zoom level, a page format, a grid layout, etc.) of an existing hanging protocol. In some examples, an existing default or custom hanging protocol configuration may display multiple images and/or series on a user display and the user may desire to, for example, adjust the spatial layout or arrangement of the images and/or series. In the example display methods and systems described herein, the user is able to specify (e.g., indicate) through the criteria the reasons why he/she made certain changes to the hanging protocol configuration. In some examples, the criteria are specific to certain image windows (e.g., locations) of a plurality of image windows on the user display. The example display methods and systems quickly save and incorporate the criteria in conjunction with the hanging protocol, without manually modifying display rules in an off-line hanging protocol editor, for future application. Capturing multiple dimensions of criteria associated with a change enables the example display systems to more accurately present imaging studies in accordance with the user's preferences. The example display methods and system described herein also enable a user to change and save presentation parameters such as, for example, the zoom of a specific image window and/or the number of image windows and arrangement of the image windows.

After the criteria (and presentation parameters) are saved with the hanging protocol, the system automatically matches the saved criteria with image data of the new image study to automatically change the presentation (e.g., configuration) of the new image study accordingly. Automatic matching and adjustment of content, layout, and/or settings (e.g., presentation parameters) of a hanging protocol to ease manual and/or repeatable configuration by a user saves user time and reduces likelihood of user error. Thus, the example display systems advantageously allow a user to quickly modify existing hanging protocols and capture the reasons/intentions of the user via the criteria to apply them in future studies to more efficiently present clinical content to a display workstation.

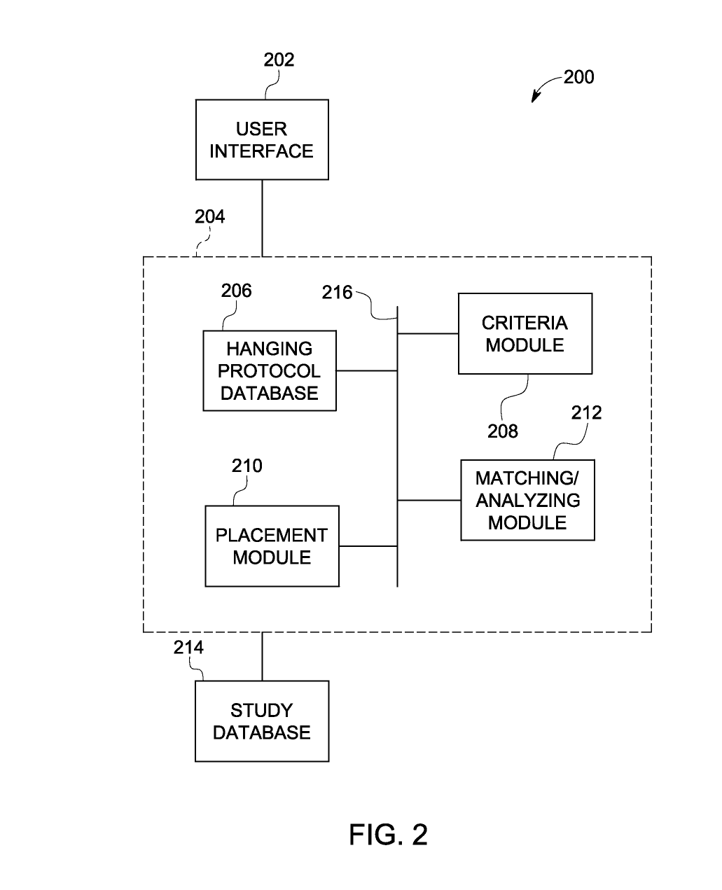

FIG. 2 depicts an example display system 200 to implement, modify and save criteria and other presentation parameters associated with changing a hanging protocol configuration. The example display system 200 includes a user interface 202, which may be, for example, the PACS workstation 140 from the system 100 shown in FIG. 1. In other examples, the user interface 202 may be any computer screen, image viewer and/or other display device known to those skilled in the art. In the example shown, the display system 200 also includes a processing unit 204 having a hanging protocol database 206, a criteria module 208, a placement module 210 and a matching/analyzing module 212. In other examples, the hanging protocol database 206 and modules 208-212 may be located offsite or in another device such as, for example, in the PACS server 130 shown and described in FIG. 1.

The example system 200 shown in FIG. 2 also includes a study database 214 for storing clinical content such as imaging studies. In other examples the study database 214 is included in the processing unit 204, a PACS server (e.g., the PACS server 130 shown in FIG. 1), an enterprise archive (“EA”), a clinical data repository, a database, and/or any other data storage facility. During a reading, a user chooses an imaging study to be presented on the user interface 202. The processing unit 204 retrieves the study from the study database 214 and presents the study on the display of the user interface 202. In some examples, the display system 200 automatically chooses a default hanging protocol or DDP to display the study. In other examples, a user chooses a hanging protocol or custom hanging protocol (e.g., a previously made hanging protocol), from the hanging protocol database 206, to present the imaging study and the images and/or series contained therein. In other examples, the display system 200 presents the imaging study to the user in a generic display and allows the user to manipulate the clinical content to create a hanging protocol. In other examples, the system 200 suggests an existing hanging protocol based on analyzing data information from the images and series in the study.

In some examples, a hanging protocol configuration displays the images and/or series of a study in one or more image windows on the user interface 202. The image windows may be arranged in a grid (e.g., 2×2, 2×3, 3×3, etc.) on the user interface 202. In some examples, the image windows represent distinct locations where images and/or series may be displayed. In other examples, the user manually arranges and creates a hanging protocol configuration on the user interface 202. The user interface 202 may receive commands and/or other input from a user via, for example, a keyboard, a mouse, a track ball, a microphone, etc.

The processing unit 204 components 206-212 are communicatively coupled to other components of the example system 200 via communication links 216. The communication links 216 may be any type of wired connection (e.g., a databus, a USB connection, etc.) or a wireless communication mechanism (e.g., radio frequency, infrared, etc.) using any past, present or future communication protocol (e.g., Bluetooth, USB 2.0, USB 3.0, etc.). Also, the components of the example system 200 may be integrated in one device or distributed over two or more devices.

As mentioned above, the user may desire to change or apply additional processing steps to one or more images and/or series of the imaging study to further enhance a plurality of features in the images and/or series. In some examples, the user may change (e.g., adjust, modify, alter) the location of certain images and/or series within the image windows to more efficiently present images for a reading. For example, if a hanging protocol presents the imaging study in a 2×2 grid with images and/or series in the different image windows, the user may move different images and/or series into different image windows. In some examples, the images and/or series displayed in certain image windows may be changed (e.g., moved, placed) in other image windows. In some examples, the images and/or series are not presently displayed (e.g., presented in a navigation window for use in the reading) and may be inserted into the different image windows. As the user changes the configuration (e.g., spatial layout, arrangement, presentation, display) of the images and/or series in the image windows, the criteria module 208 enables the user to indicate criteria as to why he/she has made such changes to the corresponding image windows. In some examples, the system 200 monitors a user's interaction with the hanging protocol, identifies a change to the hanging protocol configuration, and automatically prompts a user to select criteria when the change is made (e.g., moving a series into a different image window). In other examples, the user changes the configuration (e.g., rearranges images and/or series in different image windows), and then requests to input/select criteria associated with the change.

In the example shown, the criteria module 208 presents the user with a plurality of criteria that may be, for example, specific to an image window that was changed. For example, if a user moves a series into a first image window, the system 200 automatically identifies the change in configuration and the criteria module 208 requests the user to input/select criteria associated with that image window (e.g., why he/she move that series into that image window). In some examples, the criteria are categories of information taken from image data (e.g., the DICOM header, the modality information, collateral information associated with the image and/or series, etc.) of the image and/or series placed in the specific image window. Medical and imaging diagnostic imaging modalities include angiography, computed tomography (CT), dual energy x-ray absorptiometry (DXA), magnetic resonance imaging (MRI), nuclear medicine, optical coherence tomography (OCT), positron emission tomography (PET), ultrasound, x-ray, etc. Different image modalities include different categories of image information associated with the images and/or series such as, for example, a patient's name and demographic, a type of image, a position of the image, a format of the image, whether the image includes contrast, etc.

In some examples, the criteria include predefined categories corresponding to the categories of image data related to the images and/or series in the study. For example, in a CT reading, the image data may include categories of data such as the orientation of the image, whether the image contains contrast, when the image was produced in relation to other images, etc. In some examples, the information of the criteria are automatically generated based on the image data from the images and/or series placed in the particular image window. In some such examples, the user specifies/selects which of the categories of criteria (and the corresponding data for those criteria) to save in association with the particular image window (e.g., the reasons/intentions the user placed the series in a certain location).

For example, in a CT modalitiy, the criteria for a series may include criteria categories such as, for example, a type of study category (e.g., current, prior, baseline), a series description, a series number, a contrast, an orientation (e.g., axial, coronal, sagittal), etc. In some examples, these criteria categories may include a drop-down menu of a list of options and/or a text box for manually entering responses for each category. In some examples, “a study category” criteria includes options such as current, prior, and/or baseline. Specifying an image as current may indicate the image is from the most recent or most current study, specifying an image as prior may indicate the image is from an older or past study, and specifying an image as a baseline may indicate the image is a template or sample used as reference for comparison with other images. In other examples, the criteria do not include predefined categories and the user may manually enter the criteria.

In some examples, the user chooses or selects which of the categories of criteria (and corresponding data for those criteria) he/she prefers to save for that image window (e.g., the reason the user placed the image or series in a certain image window). After the user has specified one or more criteria (e.g., the reasons and/or explanations he/she made certain changes) the processor 204 saves these criteria with the hanging protocol, as corresponding to the specific image window, in the hanging protocol database 206. The hanging protocol includes the saved criteria for the different image windows.

In other examples, the user may change and save changes made to the presentation parameters of the hanging protocol. For example, the user may change the layout of the image windows (e.g., change the configuration of the image windows from a 2×2 to a 3×2). This change may be saved with the hanging protocol such that when the hanging protocol is applied to a different study, the same change is automatically made. In other examples, the user may change the presentation parameters of the individual image windows and/or images and/or series within the respective image windows such as, for example, a window level, a zoom, a page format, etc. The system 200 saves these presentation parameter changes as corresponding to the respective image windows such that the same changes will be made to a new study when the hanging protocol is applied to the new study.

After the criteria (and/or other presentation parameter changes) are saved, the display system 200 provides the hanging protocol and/or saved criteria in the hanging protocol database 206 for further application. When the user requests to open a new study with the hanging protocol, the matching/analyzing module 212 analyzes image information from the images and/or series within the new study. In some examples, the analysis is based on the clinical content to be displayed, the hanging protocol configuration, or the saved criteria. In some examples, the criteria are analyzed and matched against the modality information from the images and/or series. The matching/analyzing module 212 determines if the saved criteria match the image data associated with the images and/or series of the new study. If a match occurs, the placement module 210 applies the changes to the images and/or series within the hanging protocol configuration (e.g., places the matched images and/or series in the appropriate image windows). In other examples, the placement module 210 also applies the additional parameter changes saved with the hanging protocol (e.g., changes made to a window level, a zoom, a page format, etc.). Therefore, the example display system 200 advantageously increases user efficiency by learning the reasoning, via the criteria, of a user's changes to a hanging protocol configuration, quickly saves the criteria with the hanging protocol, and analyzes the criteria with respect to clinical content in a new study to decrease the time spent repeating similar changes.

For example, in a first study, a user may insert a first series into a top right image window and a second series into a bottom right image window. The user may specify certain criteria as to why he/she made those changes (e.g., the reasons for the changes). For example, the user may indicate that he/she preferred a current series in the top right image window and a prior series in the bottom right image window. The criteria are saved for each the top right image window and the bottom right image window within the entire hanging protocol. When the user opens a new study with the same hanging protocol, the matching/analyzing module 212 analyzes image data associated with the images and/or series in the new study to determine if any images and/or series matches the specified criteria for the top right image window and/or the bottom right image window. If, a match occurs, the placement module 210 makes the same changes to the hanging protocol configuration in the user interface 202 such as, for example, placing a current series in the top right image window and a prior series in the bottom right image window.

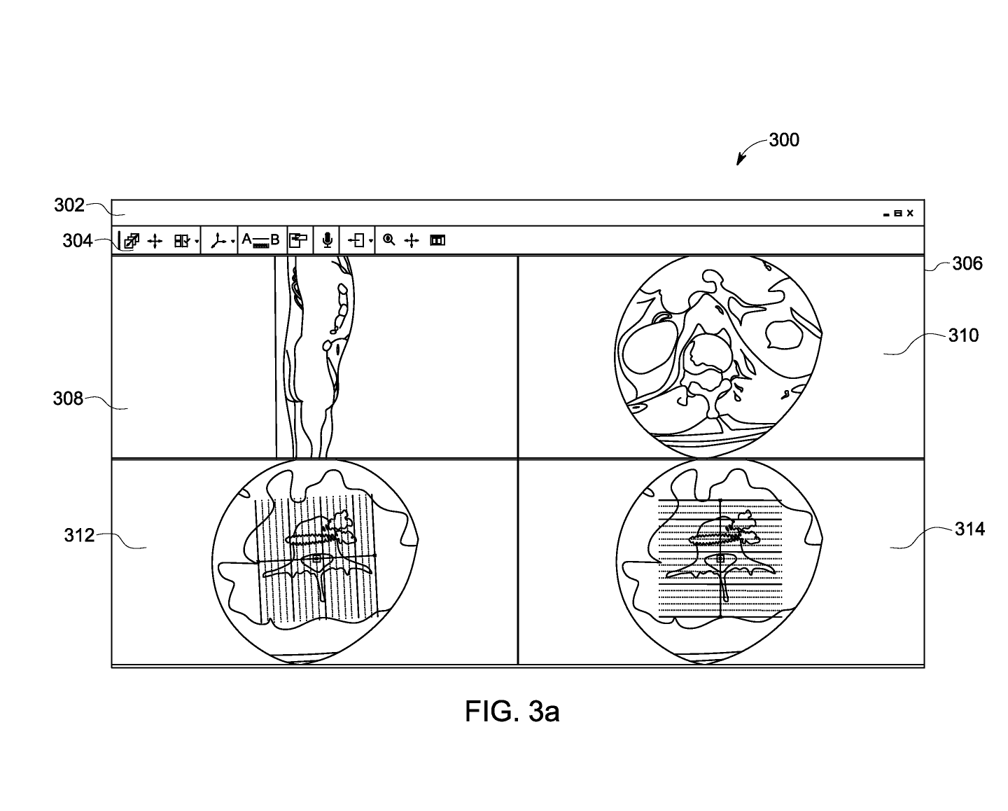

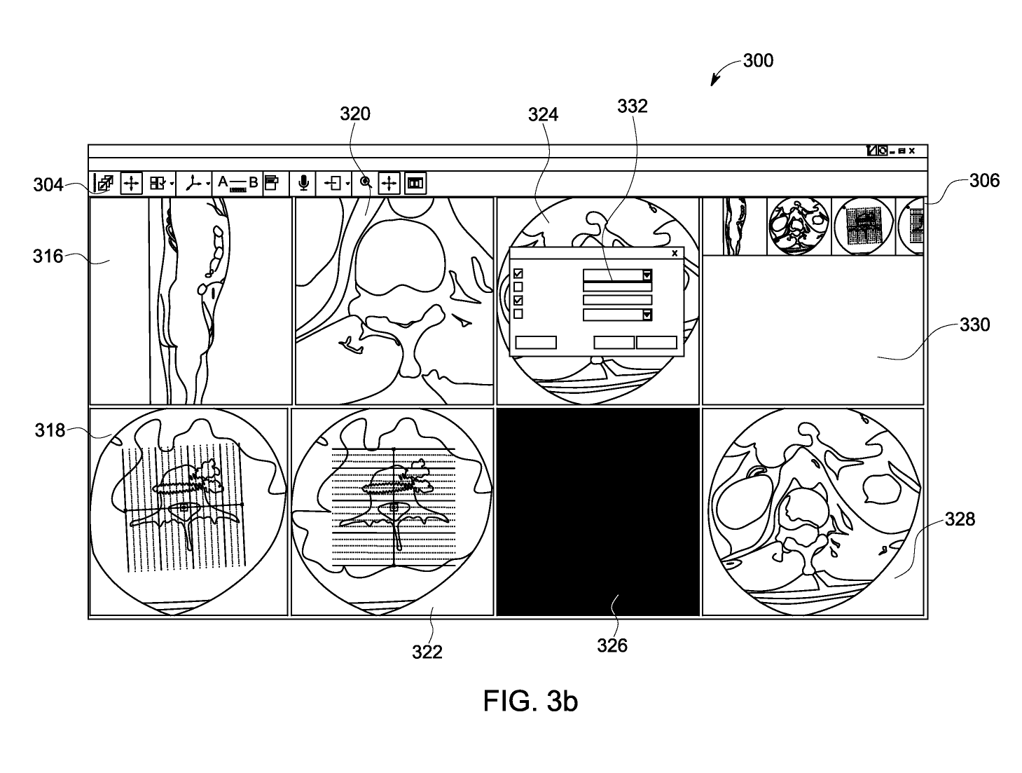

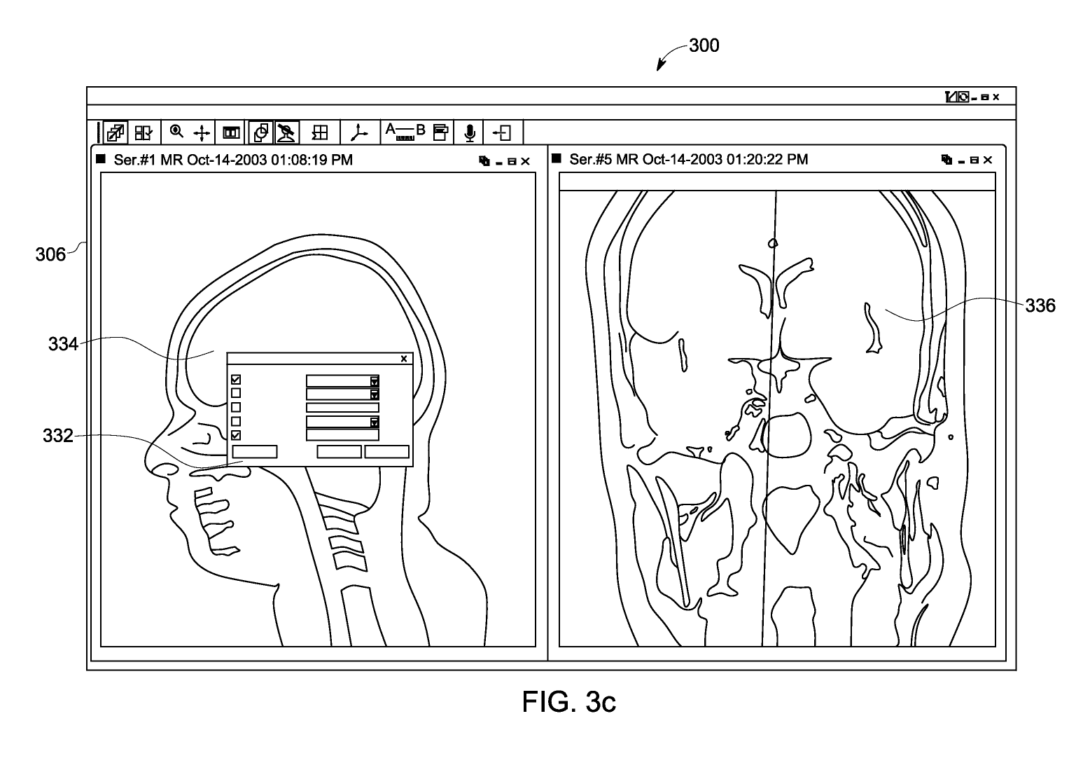

FIG. 3a depicts an example user interface 300 for reviewing images. The example user interface 300 may be displayed, for example, on the PACS workstation 140 of the system 100 in FIG. 1 or on the user interface 202 of the system 200 in FIG. 2. The example interface 300 includes a header bar 302, a tool bar 304, and a display area 306. In some examples, the header bar 302 displays a name of a study, a name of a hanging protocol, and/or any other identification information known to those skilled in the art. In the example shown, the display area 306 is divided into a 2×2 grid with image windows 308, 310, 312 and 314. However, in other examples, the display area may be divided into any number of image windows in any arrangement. In some examples, a hanging protocol includes display rules that automatically divides the display area into a particular image window arrangement and display the images and/or series according to its display rules. In other examples, a user creates a display area arrangement by choosing how he/she prefers the display area to be divided (e.g., via a hanging protocol editor).

As shown in FIG. 3a, the user interface 300 displays series in all of the image windows 308-314. In other examples, some of the image windows may be left blank or empty. A hanging protocol configuration includes a set of display rules that presents the image study according to its display rules. As mentioned above, the hanging protocol orients and/or displays the images and/or series according to the hanging protocol configuration. In some examples, a user may subsequently insert different images and/or series into different image windows and adjust the spatial layout of the presentation. In other examples, the user may change or modify presentation parameters associated with the hanging protocol (e.g., a user may change the layout from a 2×2 grid to a 3×2 grid) and/or the individual image windows (e.g., a user may change the level of zoom in an image window).

FIG. 3b depicts the example user interface 300 with an alternative display configuration. As shown, the display area 306 has been divided into a 4×2 grid including seven image windows, 316, 318, 320, 322, 324, 326, 328 and a navigation window 330. Series are displayed in image windows 316, 318, 320, 322, 324 and 328. In the example shown image window 326 is left blank. In some examples, the hanging protocol dictates the configuration of the display screen, the placement of images, the presentation of images, etc. The navigation window 330 is a window that displays thumbnails of the images in the image windows 316-328 and, thus, displayed in the display area 306. The navigation window 330 reflects the current layout of images in a miniature layout and enables a user to change that layout through dragging and dropping and/or other placement of an image and/or series. In some examples, the navigation window shows a thumbnail and/or other listing of all available images and/or series for the imaging study that a user can select one or more image thumbnails and place them in the layout via the mini-layout and/or by directly placing them in the image windows 316-328 of the display area 306. In some examples, the navigation window is located in other image windows, or not displayed at all. In some examples, the navigation window includes additional images and/or series that are not currently displayed but are contained in the study. In some examples, a mouse and/or keyboard may be used to operate the functions of the user interface 300.

As shown in FIG. 3b, the user interface 300 displays the images and/or series of the imaging study according to the hanging protocol configuration. The user interface 300 allows the user to employ a variety of tools (e.g., from the tool bar 304) to change and/or manipulate the arrangement, layout, and the display of the images and/or series within the display area 306. If the user makes a change, the user interface 300 presents a hanging criteria window 332 for receiving criteria regarding why and/or how the change was made. For example, as shown in FIG. 3b, the user has placed an image or series in the imaging window 324. In some examples, the system monitors the user's interaction with the hanging protocol, identifies a change in the hanging protocol configuration (e.g., placing an image or series in an image window), and automatically presents the hanging criteria window 332 to the user. In other examples, the user makes the change and then requests to input his/her reasoning and/or explanation into the hanging criteria window 332 corresponding to the image window.

In the example shown, the criteria window 332 allows the user to input/select one or more criteria corresponding to the reason(s) for the change to the hanging protocol configuration. In the example shown, the criteria in the hanging criteria window 332 are associated with a certain image window (e.g., the image window 324), discussed in detail below.

In some examples, the user may change the presentation parameters of the entire hanging protocol (e.g., the number and/or layout of the image windows) and/or the individual image windows and save the changes with the hanging protocol. In some examples, the user may change the presentation parameters (e.g., the layout, the arrangement, the configuration) of the image windows. For example, the user may change the configuration of the image windows from a 2×2 grid as shown in FIG. 3a to a 4×2 grid as shown in FIG. 3b. When the system applies the saved hanging protocol to a new study, the system will automatically reconfigure the arrangement of the image windows accordingly. In other examples, a user may change the presentation parameters (e.g., a window level, a level of zoom, a page format, etc.) of the individual image windows. For example, the user may adjust the zoom level of an image and/or series within a particular image window such as, for example, as shown in FIG. 3b where the image window 320 is displaying a zoomed-in view of the image or series also shown in the image window 324. After making the change to the presentation parameters of the image window 320, the user may save the hanging protocol or the system may automatically save the hanging protocol after the change is made. In operation, when the hanging protocol is applied to a new study, the system will present a zoomed-in view of the image or series in the image window 320.

FIG. 3c depicts the example user interface 300 with an alternative display configuration. As shown, the display area 306 is divided into a 2×1 grid with images or series in each image window 334 and 336. In the example shown, a user moves a series into image window 334. The hanging criteria window 332 presents the user with a plurality of criteria that he/she may select as corresponding to the reasons he/she moved the series into image window 334. In some examples, the criteria are chosen from categories of image data (e.g., categories or DICOM header information, modality information, etc.) associated with the image or series in the image window 334. In the example shown, the hanging criteria window 332 automatically generates the criteria categories and corresponding information for those categories associated the series in the image window 334. In the example shown, the user may select one or more categories of criteria (and corresponding information for those categories) to save as corresponding to the image window 334. The hanging criteria for the image window 334 may then be saved with the hanging protocol. Thus, when the user opens a new study with the hanging protocol (and saved criteria), the system analyzes the image data from the images and/or series in the new study for information that matches the criteria corresponding to image window 334. If a match occurs, the system places that image or series in the image window 334 and, thus, changes the hanging protocol configuration.

In some examples, the criteria include predefined categories such as, for example, the type of study category (e.g., current, prior, baseline), a series description, a series number, a contrast, and/or an orientation (e.g., axial, side) of the image. In other examples, the criteria window 332 accepts manually entered criteria for the change made to the hanging protocol configuration. Once the reason(s) and/or explanation(s) have been indicated via the one or more criteria, the criteria are saved with the hanging protocol.

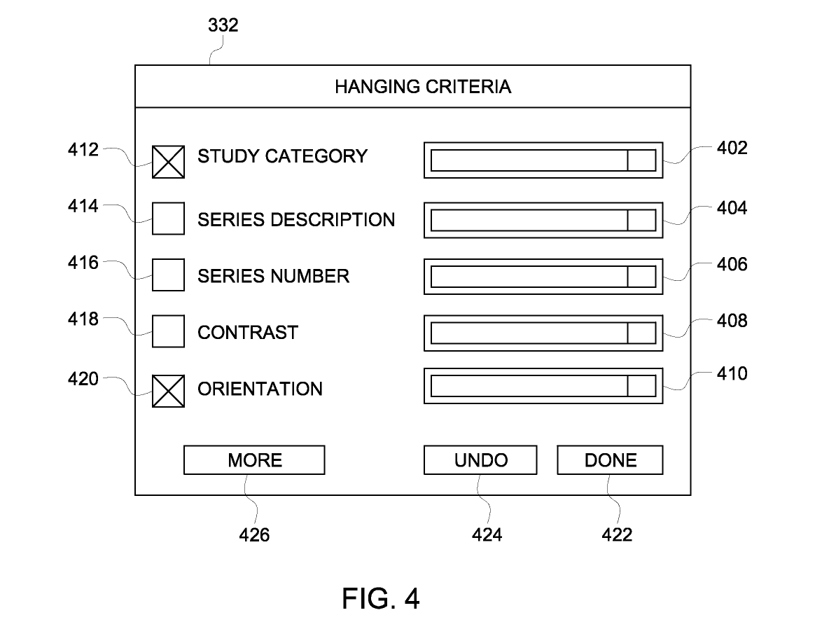

FIG. 4 illustrates an enlarged view of the example hanging criteria window 332 that allows a user into input and/or select criteria used when changing the hanging protocol configuration. In the example shown, the hanging criteria window 332 presents five categories of criteria, “Study Category,” “Series Description,” “Series Number,” “Contrast” and “Orientation.” In other examples, the hanging criteria window 332 may present more or fewer categories of criteria. In some examples, the categories of criteria are the same as the categories of information relating to the image data (e.g., categories of information taken from the DICOM header, the modality information, the collateral information, etc.).

In the example hanging criteria window 332 shown, each category includes a respective input box 402, 404, 406, 408 and 410 for inputting the criteria (e.g., the information, the answers, the labels) to those categories. In some examples, the input boxes 402-410 are dropdown menus including predefined lists of options. For example, the “Study Category” input box 402 may include a dropdown menu with three options to choose from, “current,” “prior,” or “baseline.” “Current” may indicate the series is from a current study, “prior” may indicate the series is from a study conducted in the past, and “baseline” may indicate the series is a template or reference. In another example, the “Contrast” category may include a “Yes” and “No” option, which may indicate whether any artificial contrast has been applied to the series or image (e.g., the image was taken with a dye to enhance visibility). In another example, the “Orientation” category may include “axial,” “coronal,” and “sagittal” as options, which enables the user to specify the orientation of the series or image. In other examples, the input boxes 402-410 accept manual input (e.g., the user may type in the input boxes 402-410), described in further detail below.

In the example hanging criteria window 332 shown in FIG. 4, each category of criteria also includes a respective selection box 412, 414, 416, 418 and 420. The selection boxes 412-420 allow the user to specify or select which of the criteria (and corresponding information) to save. In some examples, the selected criteria correspond to the important or preferred criteria the user considered when inserting a series into the corresponding image window. In the example shown, a user has chosen the “Study Category” and “Orientation” categories, as indicated by the “X” in selection boxes 412 and 420. For example, if the “Orientation” criteria indicated “axial” in the input box 410, and the “Study Category” criteria indicated “prior” in the input box 402, then the criteria for changing the hanging protocol would comprise an image or series in a prior study with an axial orientation.

In other examples, the user may select or choose the criteria by highlighting the text of the category. In other examples, a user may select the category by any other means known to those skilled in the art. To save the selected criteria and the corresponding inputs, the hanging criteria window 332 includes a “DONE” button 422. Once the user has selected and specified the criteria he/she prefers, the user may press the “DONE” button 422 to close the hanging criteria window 332 and save those criteria associated with the particular image window in the hanging protocol. The hanging criteria window 332 also includes an “UNDO” button 424 and a “MORE” button 426, described in further detail below.

In another example, the user chooses/inputs “current” in the input box 402 for the “Study Category” criteria, and “axial” in the input box 410 for the “Orientation” criteria, and the system saves these two criteria for the corresponding image window. In this example, the user has selected to save these two criteria. If the same hanging protocol is applied to a different study, the system will analyze the image data (e.g., the DICOM header information, the modality information, the collateral information associated with the image or series, etc.) in the images and/or series in the study for a “current” image and/or series with an “axial” orientation. If a match occurs, the system changes the display configuration of the hanging protocol and transfers (e.g., moves, places, changes) that series into the corresponding image window. If a match does not occur, then the system will make no further changes to the hanging protocol configuration.

In some examples, a user may manually enter information into the input boxes 402-410 for the respective categories. For example, in the “Series Description” category, a user may enter “abdomen” in the indication box 404. When the hanging protocol is applied to a new study, the system will analyze the image data of the images and/or series in the new study for the word “abdomen.” If there is a match, the system will place that image and/or series in the corresponding image window. In another example, for the “Series Number” category, a user may enter “2” into the input box 406. When applying the hanging protocol to a new study, the system will analyze the series in the new study and place the second “2” series in the corresponding image window.

In some examples, the user does not need to select all of the categories of criteria (e.g., the user may select one, two, etc.). Additionally, any number of criteria may be used and displayed within the hanging criteria window 332. In the example shown, the user may choose the “UNDO” button 424 if he/she is unsatisfied with his/her selection. In the example shown, the user may choose the “MORE” button 426 to present additional criteria and/or categories of criteria. Additional criteria may include other categories of criteria associated with the image and/or series placed in the image window such as, for example, “Dual Echo,” “Image Type 1” (e.g., where the series was constructed, such as original, derived, mixed, etc.), “Image Type 2” (e.g., primary or secondary), etc. An unlimited number of criteria categories may be used to capture the user's reasons for changing the hanging protocol configuration.

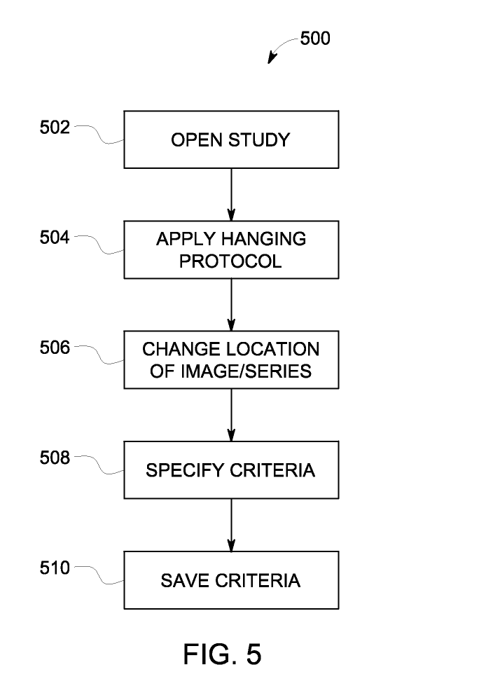

FIG. 5 illustrates a flow diagram of an example method 500 to capture and save criteria (and/or other presentation parameters) relating to a change made to a hanging protocol configuration, and implementing the systems 100 and 200, and the user interface display 300, shown in FIGS. 1-4. At block 502, a user opens a study within a user interface or display screen such as, for example, the PACS workstations 140 of the system 100 shown in FIG. 1, the user interface 202 of the system 200 shown in FIG. 2, or the user interface display 300 shown in FIGS. 3a-3c. The study may be retrieved, for example, from the PACS server 130 of the system 100 shown in FIG. 1 or the study database 214 of the system 200 shown in FIG. 2. At block 504, a hanging protocol is applied to the study on the user interface or the user views the study in a generic display and makes his/her desired changes (e.g., manipulates the presentation of the study). As mentioned above, a hanging protocol is a set of display rules for displaying and presenting images and/or series in a study. In some examples, the hanging protocol is a default hanging protocol or a custom hanging protocol. The hanging protocol may be retrieved from, for example, the PACS server 130 of the system 100 shown in FIG. 1 or the hanging protocol database 206 of the system 200 shown in FIG. 2. The hanging protocol arranges, orients, manipulates, and/or displays the images and series on the user interface in accordance with the hanging protocol configuration. In some examples, the hanging protocol arranges series of images in a one or more image windows. In some such examples, the image windows are arranged in grids (e.g., 1×2, 2×2, 2×3, etc.).

At block 506, a user makes a change to the hanging protocol configuration. As mentioned above, the user interface includes a variety of tools such as, for example, in the tool bar 304 of the user interface 300 shown in FIG. 3a. In some examples, the user changes the location of an image and/or series by placing the image and/or series in a different image window. For example, the user may pull a series from a navigation window and insert it into a top right image window. In another example, the user may take a series from a top right image window and place it into a bottom right image window. In some examples, the user divides the display into a different arrangement of image windows. For example, the hanging protocol may present the series in a 2×2 arrangement and the user may choose to add two more image windows (e.g., 3×2). The user may then place new series in different image windows or change the location of the series. Within the different image windows the user may make further changes to the presentation parameters of the images and/or series in the individual image windows such as, for example, changing the a window level, a level of zoom, a page format, etc.

At block 508, the user indicates the reasons via the criteria that he/she changed the hanging protocol configuration. The criteria may be the criteria described above in the hanging criteria window 332 of the user interface 300 shown in FIGS. 3a-4. In some examples, the criteria include predefined categories such as, for example, a type of study category (e.g., current, prior, baseline), a series description, a series number, a contrast, and/or an orientation (e.g., axial) of the image in the image window. In other examples, the criteria include where the series was constructed (e.g., original, derived, mixed, etc.), primary or secondary, axial or localized, etc. In some examples, the categories of criteria correspond to categories of image data pulled from the series.

At block 510, the criteria are saved within the hanging protocol as corresponding to the specific image window. In some examples, different criteria are saved for different image windows within the hanging protocol. In some examples, the presentation parameter changes to the entire hanging protocol and/or the image windows are also saved with the hanging protocol.

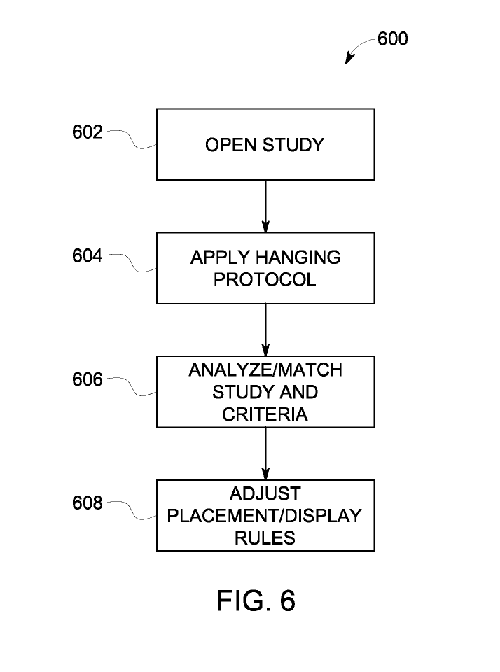

FIG. 6 illustrates a flow diagram of an example method 600 to apply a hanging protocol configuration with saved criteria (and/or presentation parameter changes) and implement the systems 100 and 200, and the user interface display 300, shown in FIGS. 1-4. At block 602, a user opens a new study or second study. The user opens the new study within a user interface or display screen such as, for example, the PACS workstations 140 of the system 100 shown in FIG. 1, the user interface 202 of the system 200 shown in FIG. 2, or the user interface display 300 shown in FIGS. 3a-3c. The second study may be retrieved from, for example, the PACS server 130 of the system 100 shown in FIG. 1 or the study database 214 of the system 200 shown in FIG. 2.

At block 604, the hanging protocol is applied to the image study. The hanging protocol may be retrieved from, from example, the PACS server 130 of the system 100 shown in FIG. 1 or the hanging protocol database 206 of the system 200 shown in FIG. 2. In the illustrated example, the hanging protocol includes the saved criteria (and/or other presentation parameter changes) from blocks 508 and 510 described in FIG. 5. In some examples, the saved criteria correspond to an image window in a plurality of image windows. In some examples, multiple image windows include saved criteria.

At block 606, the images and/or series of the study are analyzed and matched to the criteria of the one or more image windows. In some examples, the analysis is based on image data (e.g., the DICOM header information, the modality information, etc.) related to the images and/or series in the new study. The analyzing/matching may be conducted by, for example, the matching/analyzing module 212 of the system 200 shown in FIG. 2.

At block 608, the images are adjusted, replaced and/or manipulated according to the matched criteria (and/or the presentation parameter changes). For example, if a user previously specified a study category of a prior image is to be placed in a top left image window, the system will analyze the image and/or series of the new study for an image and/or series from a prior study and, if matched, place it the top left image window. In other examples, the hanging protocol may include saved presentation parameter changes and at block 608 the changes may be applied to the new study (e.g., changing the level of a zoom in an image window).

The example methods and systems described herein capture and save criteria for making a change to a hanging protocol configuration, and apply, where applicable, the criteria to another image study by changing the hanging protocol configuration. The examples advantageously decrease user time and, thus, increase efficiency of a reading.

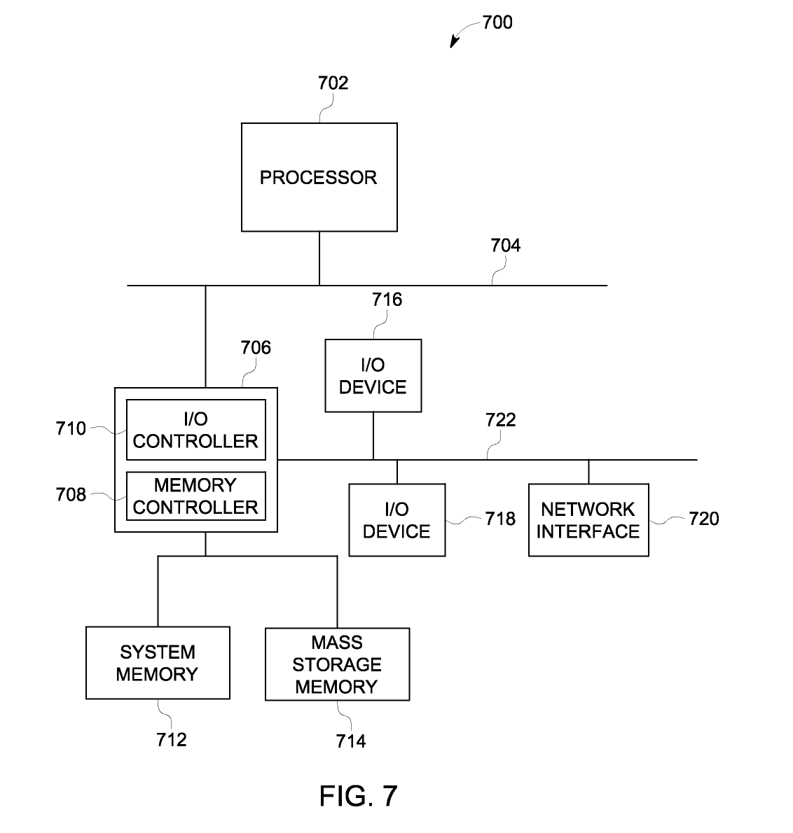

FIG. 7 is a block diagram of an example processor system 700 that may be used to implement the systems and methods described herein such as, for example, the systems 100 and 200, and corresponding user interface display 300, of FIGS. 1-4 and the methods 500 and 600 of FIGS. 5-6. As shown in FIG. 7, the processor system 700 includes a processor 702 that is coupled to an interconnection bus 704. The processor 702 may be any suitable processor, processing unit or microprocessor. Although not shown in FIG. 7, the processor system 700 may be a multi-processor system and, thus, may include one or more additional processors that are identical or similar to the processor 702 and that are communicatively coupled to the interconnection bus 704.

The processor 702 of FIG. 7 is coupled to a chipset 706, which includes a memory controller 708 and an input/output (I/O) controller 710. As is well known, a chipset typically provides I/O and memory management functions as well as a plurality of general purpose and/or special purpose registers, timers, etc. that are accessible or used by one or more processors coupled to the chipset 706. The memory controller 708 performs functions that enable the processor 702 (or processors if there are multiple processors) to access a system memory 712 and a mass storage memory 714.

The system memory 712 may include any desired type of volatile and/or non-volatile memory such as, for example, static random access memory (SRAM), dynamic random access memory (DRAM), flash memory, read-only memory (ROM), etc. The mass storage memory 714 may include any desired type of mass storage device including hard disk drives, optical drives, tape storage devices, etc.

The I/O controller 710 performs functions that enable the processor 702 to communicate with peripheral input/output (I/O) devices 716 and 718 and a network interface 720 via an I/O bus 722. The I/O devices 716 and 718 may be any desired type of I/O device such as, for example, a keyboard, a video display or monitor, a mouse, etc. The network interface 720 may be, for example, an Ethernet device, an asynchronous transfer mode (ATM) device, an 802.11 device, a DSL modem, a cable modem, a cellular modem, etc. that enables the processor system 700 to communicate with another processor system.

While the memory controller 708 and the I/O controller 710 are depicted in FIG. 7 as separate blocks within the chipset 706, the functions performed by these blocks may be integrated within a single semiconductor circuit or may be implemented using two or more separate integrated circuits.

Certain example implementations contemplate methods, systems and computer program products on any machine-readable media to implement functionality described above. Certain example implementations may be implemented using an existing computer processor, or by a special purpose computer processor incorporated for this or another purpose or by a hardwired and/or firmware system, for example.

Certain example implementations include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

The example systems and methods described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The example methods and apparatus described herein may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for displaying clinical content, the method comprising:
monitoring user interaction with an image viewer displaying clinical content to a user according to a hanging protocol;
identifying a change in configuration of the hanging protocol;
capturing, based on user input, criteria associated with the change;
saving the criteria in association with the hanging protocol; and
providing the hanging protocol and associated criteria for selection and application to clinical content to be displayed.

2. The method of claim 1 further comprising automatically applying the hanging protocol to clinical content based on an analysis of one or more of the clinical content to be displayed, the hanging protocol configuration, or the saved criteria.

3. The method of claim 1, wherein the change in configuration comprises a change in spatial layout.

4. The method of claim 1, wherein the saved criteria is specific to one image window of a plurality of image windows.

5. The method of claim 1, wherein the criteria comprise one or more predefined categories of criteria.

6. The method of claim 5, wherein the one or more predefined categories of criteria correspond to categories of image data.

7. The method of claim 6 further comprising matching the criteria to the image data.

8. The method of claim 7 further comprising changing a spatial layout of clinical content based on the matching.

9. A system for displaying clinical content, the system comprising:
a user interface to display clinical content to a user according on a hanging protocol; and
a processing unit to:
identify a change in configuration of the hanging protocol made by the user interacting with the clinical content;
present the user with criteria associated with the change;
capture, based on user input, one or more of the criteria;
save the criteria with the hanging protocol; and
provide the hanging protocol for application to clinical content to be displayed.

10. The system of claim 9, wherein the change in configuration comprises a change in a spatial arrangement of an image or a series.

11. The system of claim 10, wherein the change in spatial arrangement of the series comprises changing the location of the series in a plurality of image windows.

12. The system of claim 9, wherein the criteria is specific to an image window of a plurality of image windows.

13. The system of claim 12, wherein the criteria comprises one or more predefined categories of criteria.

14. The system of claim 13, wherein the processor is to match the criteria to one or more series of different clinical content.

15. The system of claim 14, wherein the processing unit is to present the user with the criteria automatically when a change in configuration is identified.

16. A tangible computer readable medium having a set of instructions that when read, cause the computer to at least:
display a first image study to a user based on a hanging protocol configuration;
monitor user interaction with content of the first image study;
identify a change in configuration of the hanging protocol;
capture criteria associated with the change;
save the criteria in association with the hanging protocol; and
provide the hanging protocol and saved criteria for selection and application to a second image study different than the first image study.

17. The tangible computer readable medium of claim 16, wherein the hanging protocol is to be automatically applied to the second image study based on an analysis of content of the second image study to be displayed, the hanging protocol configuration, or the saved criteria.

18. The tangible computer readable medium of claim 16, wherein the change in configuration comprises a change in spatial orientation of a series.

19. The tangible computer readable medium of claim 16, wherein the saved corresponds to one image window of a plurality of image windows.

20. The tangible computer readable medium of claim 16, wherein the instructions further cause the computer to match the criteria to content of the second image study.
